(19) United States
(12) Patent Application Publication
(10) Pub. No.: US 2020/0057722 A1
(43) Pub. Date: Feb. 20, 2020

(54) DATA READING METHOD BASED ON VARIABLE CACHE LINE

(71) Applicant: Nanjing Iluvatar CoreX Technology Co., Ltd. (DBA “Iluvatar CoreX Inc. Nanjing”), Nanjing (CN)

(72) Inventors: Yongliu Wang, Shanghai (CN); Pingping Shao, San Jose, CA (US); Chenggen Zheng, Shanghai (CN); Jinshan Zheng, Shanghai (CN)

(73) Assignee: Nanjing Iluvatar CoreX Technology Co., Ltd. (DBA “Iluvatar CoreX Inc. Nanjing”), Nanjing (CN)

(21) Appl. No.: 16/237,612

(22) Filed: Dec. 31, 2018

(30) Foreign Application Priority Data
Aug. 16, 2018 (CN) 201810931880.2

(51) Int. Cl. G06F 12/0886

(52) U.S. Cl. CPC G06F 12/0886; G06F 2212/60

(57) ABSTRACT

A data reading and writing method based on a variable length cache line. A lookup table stores cache line information of each request. When a read task arrives at the cache, the cache line information is obtained according to the request index, and the request is hit. The data in the cache is read and sent to the requester in multiple cycles, otherwise the request is not in the cache, some read requests are created and sent. The offset, tag and cache line size are recorded in the record of the lookup table, and the request is sent to the DRAM. Once all the data is returned and written to the cache, the corresponding record of the lookup table is set to be valid.

### CROSS-REFERENCE TO RELATED APPLICATION

This US nonprovisional patent application claims priority to a Chinese invention application serial number 201810931880.2, filed on Aug. 16, 2018, whose disclosure is incorporated by reference in its entirety herein.

### TECHNICAL FIELD

Aspects of the invention generally relate to a data reading and writing method, and more particularly to a data reading and writing method based on a variable length cache line.

### BACKGROUND

Generally, for convenience of control and management, the cache lines are of equal length, but in actual implementations, the proportion of valid data in the same length data is changeable. For example, the bus is always read/written to the bus a part of invalid data. As such, the bus bandwidth is wasted; and some invalid data is stored in the cache, resulting that the cache utilization is reduced. The number of valid cache lines per data is also different. For example, if one were to use the same length of cache line, the cache would have a lot of invalid data. Variable cache lines save the number of data cache lines per data stream. If one does not have a variable cache line, one would need the longest number of cache lines in the data to store each data.

Suppose there are four pieces of data. The first, second, and third pieces require two cache lines, but the fourth piece of data requires eight cache lines. If one uses the equal length strategy, one would need 32 cache lines. If one uses the unequal length strategy, you may only need 14 cache lines, thus saving 18 cache lines. These cache lines may store other data.

Therefore, it is beneficial to provide a data reading and writing method of unequal length strategy to improve data reading and writing efficiency.

### SUMMARY

Aspects of the invention provide a technical solution to a technical problem by providing a data reading and writing method based on a variable length cache line.

In one embodiment, in order to solve the above technical problem, the technical solution incorporating aspects of the invention may include:

A method for reading and writing data based on a variable length cache line comprising the steps of:

Step 1: The data may be arranged in a circular buffer manner in the cache, and a lookup table may be configured or set between a flag information and data. In one example, the lookup table may be also managed in a ring buffer manner;

Step 2: If a cache receives the read request, first check whether the request hits a valid record already in the lookup table;

Step 3: If a record of the same mark is found in the lookup table, the read request hits the cache, reads the data offset and the data size from the hit record, and then reads the corresponding data in the data cache and returns to the requester;

Step 4: If there is no hit, add a new record to the lookup table;

Step 5: moving the head pointer to obtain an entry in the lookup table;

Step 6: If this is a valid entry, release its data in the data cache and allocate the required size in the data cache;

Step 7: If the available size in the data cache is less than the required size, then more entries are released in order in the lookup table until there is enough space. In one embodiment, the request is sent to the DRAM. Once all the data is returned and written Into the cache, the corresponding record of the lookup table is set to be valid;

Step 8: If the cache receives the write request, add a new record to the lookup table;

Step 9: moving the head pointer and obtaining an entry in the lookup table;

Step 10: If this is a valid entry, release its data in the data cache and allocate the required size in the data cache;

Step 11: If the size available in the data cache is less than the required size, then more entries are released in order in the lookup table until there is enough space;

Step 12: Then use the data cache to update the information, offset, and request size of the corresponding record in the lookup table, and write the data to the data cache to make the cache line valid.

In one embodiment, in Step 1, if the head pointer to the tail pointer is greater than 1, the data buffer has (head pointer—tail pointer—1) valid entries; if the head pointer is equal to the tail pointer, the data buffer is empty.

In a further embodiment, the step 2 checks whether the request hits the valid record existing in the lookup table by comparing the mark of the read request with the mark in all valid records in the lookup table.

Further, in order to release data in the data cache, the cache line size corresponding to the data is added to the tail pointer; in order to update the data cache, the data is written into the data cache, and its cache line size is added to the head pointer; in order to check whether there is k available entries, make sure (header-tail pointer −k) >1.

Further, the lookup table stores cache line information of each request, and the cache line information includes a valid bit, a cache offset, a cache line size, and a request flag.

Further, the request includes a tag and an index to the lookup table, which has a variable valid data length, the data length being calculated based on the metadata of the request.

Compared with the prior art, aspects of the invention provide at least the following advantages and effects: according to the data characteristics, the embodiments of the invention only read, write, and store valid data, effectively utilizes bus bandwidth and cache space, thereby increasing the bus width and improving the bus width. The frequency increases the physical capacity of the cache.

### DETAIL DESCRIPTION OF DRAWINGS

In order to more clearly describe the technical schemes in the specific embodiments of the present application or in the prior art, hereinafter, the accompanying drawings required to be used in the description of the specific embodiments or the prior art will be briefly introduced. Apparently, the drawings described below show some of the embodiments of present application, and for those skilled in the art, without expenditure of creative labor, other drawings may be derived on the basis of these accompanying drawings.

FIG. 1 is a schematic diagram of a cache structure of a data read/write method based on a variable length cache line according to the embodiments of the invention.

FIG. 2 is a schematic diagram of a data read and write method based on a variable length cache line according to one embodiment of the invention.

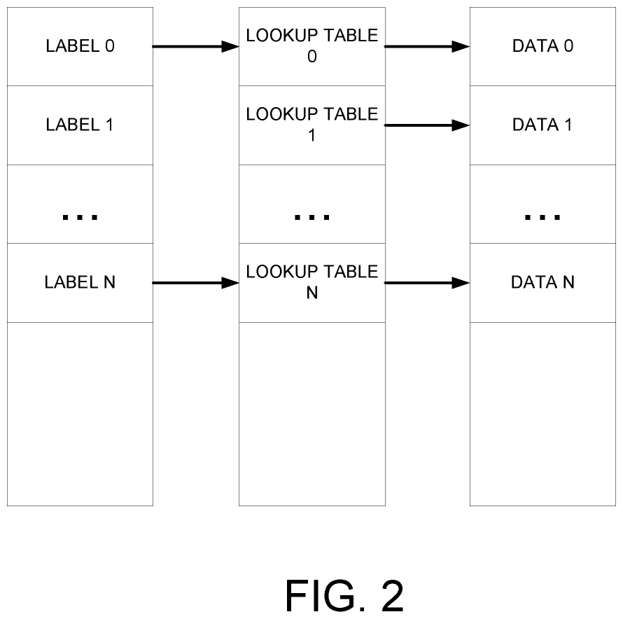

### DETAILED DESCRIPTION

Embodiments of the invention may now be described more fully with reference to the accompanying drawings, which form a part hereof, and which show, by way of illustration, specific exemplary embodiments by which the invention may be practiced. These illustrations and exemplary embodiments may be presented with the understanding that the present disclosure is an exemplification of the principles of one or more inventions and may not be intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the embodiments of the invention may be embodied as methods, systems, computer readable media, apparatuses, or devices. Accordingly, the embodiments of the invention may take the form of an entirely hardware embodiment, an entirely software embodiment, or an embodiment combining software and hardware aspects. The following detailed description may, therefore, not to be taken in a limiting sense.

Aspects of the invention may now be further described in detail below with reference to the accompanying drawings.

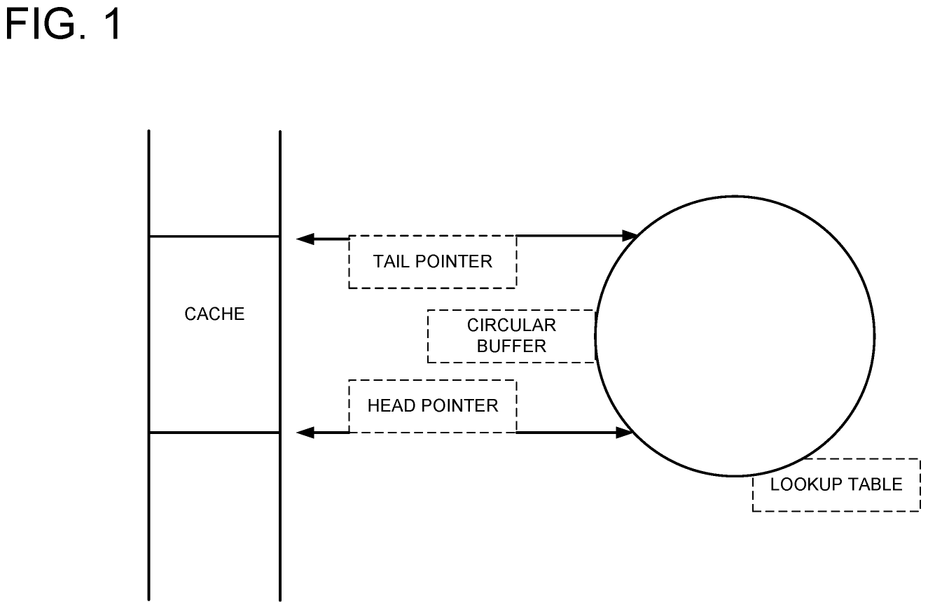

As shown in FIG. 1 , a method for reading and writing data based on a variable length cache line according to the embodiments of the invention that the method comprises the following steps:

Step 1: The data is arranged in a circular buffer in the cache, and a lookup table is set between the flag information and the data, and the lookup table is also managed in a ring buffer manner;

Since the data length is not fixed, you need to add a lookup table (LUT) to connect the flags and data. The data is arranged in a circular buffer in the cache. Lookup tables may also be managed in a circular buffer. If the head pointer to the tail pointer is greater than 1, the data cache has (head pointer—tail pointer—1) valid entries. If the head pointer is equal to the tail pointer, the data cache is empty. Lookup tables are also updated in this circular buffer. If the cache receives a write request, move the head pointer and get the entry in the lookup table. If this is a valid entry, its data is released in the data cache and allocate the required size in the data cache. If the size available in the data cache is less than required, then more entries are released in order in the lookup table until there is enough space. The information in the lookup table is then updated, the offset and the request size, and the data is written to the data cache and the record is valid.

In order to release the data in the data cache, in one embodiment, the cache line size may be added corresponding to the data to the tail pointer. To update the data cache, the data is written to the data cache and add its cache line size to the head pointer. In order to check if there are k available entries, (header-tail pointer −k) >1 is ensured to be true.

Step 2: If the cache receives the read request, first check whether the request hits a valid record already in the lookup table; this is determined by comparing the mark of the read request with the mark in all valid records in the lookup table.

Step 3: If a record of the same mark is found in the lookup table, the read request hits the cache, reads the data offset and the data size from the hit record, and then reads the corresponding data in the data cache and returns it to the requester;

Step 4: If there is no hit, add a new record to the lookup table;

Step 5: Move the head pointer to get an entry in the lookup table;

Step 6: If this is a valid entry, release its data in the data cache and allocate the required size in the data cache;

Step 7: If the available size in the data cache is less than the required size, then release more entries in the lookup table in order until there is enough space; send the request to the DRAM, once all the data is returned and written to the cache, The corresponding record of the lookup table is set to be valid;

Step 8: If the cache receives the write request, add a new record to the lookup table;

Step 9: Move the head pointer and get the entry in the lookup table;

Step 10: If this is a valid entry, release its data in the data cache and allocate the required size in the data cache;

Step 11: If the size available in the data cache is less than the required size, then release more entries in the lookup table in order until there is enough space;

Step 12: Then use the data cache to update the information, offset, and request size of the corresponding record in the lookup table, and write the data to the data cache to make the cache line valid.

The working principle of the embodiments of the invention is that in a cache with variable cache lines, there is a lookup table to store cache line information for each request. This information includes the valid bit, the cache offset, the cache line size, and the request tag. The request is split into two parts: the tag and the index to the lookup table. It has a variable valid data length that is calculated based on the metadata of the request. When a read task arrives at the cache, the cache line information is obtained according to the request index. If this is a valid cache line, and the label of this cache line is equal to the requested label, this means that the request hits the cache. According to the cache offset and cache line size in the cache line information, the data in the cache is more. It is read and sent to the requester in a cycle. Otherwise, the request is not in the cache and some read requests are created and sent out. To make these requests, some space is needed in the cache. The amount of space is the requested data length. If space is not enough, some cache lines are set to invalid and the space they occupy is freed. The Offset, tag, and the cache line size are recorded into the lookup table's record and send the request to DRAM. Once all the data is returned and written to the cache, the corresponding record in the lookup table is set to be valid.

The above description in this specification is merely illustrative of the invention. A person skilled in the art may make various modifications or additions to the specific embodiments described or replace them in a similar manner, as long as they do not deviate from the scope of the present specification or beyond the scope defined by the claims. It belongs to the scope of protection of the embodiments of the invention.

Apparently, the aforementioned embodiments are merely examples illustrated for clearly describing the present application, rather than limiting the implementation ways thereof. For a person skilled in the art, various changes and modifications in other different forms may be made on the basis of the aforementioned description. It is unnecessary and impossible to exhaustively list all the implementation ways herein. However, any obvious changes or modifications derived from the aforementioned description are intended to be embraced within the protection scope of the present application.

The example embodiments may also provide at least one technical solution to a technical challenge. The disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

The terms “including,” “comprising” and variations thereof, as used in this disclosure, mean “including, but not limited to,” unless expressly specified otherwise.

The terms “a,” “an,” and “the,” as used in this disclosure, means “one or more,” unless expressly specified otherwise.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, may comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

While the disclosure has been described in terms of exemplary embodiments, those skilled in the art will recognize that the disclosure may be practiced with modifications that fall within the spirit and scope of the appended claims. These examples given above are merely illustrative and are not meant to be an exhaustive list of all possible designs, embodiments, applications, or modification of the disclosure.

In summary, the integrated circuit with a plurality of transistors, each of which may have a gate dielectric with properties independent of the gate dielectric for adjacent transistors provides for the ability to fabricate more complex circuits on a semiconductor substrate. The methods of fabricating such an integrated circuit structures further enhance the flexibility of integrated circuit design. Although the invention has been shown and described with respect to certain preferred embodiments, it is obvious that equivalents and modifications will occur to others skilled in the art upon the reading and understanding of the specification. The embodiments of the invention include all such equivalents and modifications, and is limited only by the scope of the following claims.

What is claimed is:

1. A method for reading and writing data based on a variable length cache line, comprising the steps of:
Step 1: The data is arranged in a circular buffer in the cache, and a lookup table is set between the flag information and the data, and the lookup table is also managed in a ring buffer manner;
Step 2: If the cache receives the read request, first check whether the request hits a valid record already in the lookup table;
Step 3: If a record of the same mark is found in the lookup table, the read request hits the cache, reads the data offset and the data size from the hit record, and then reads the corresponding data in the data cache and returns it to the requester;
Step 4: If there is no hit, add a new record to the lookup table;
Step 5: Move the head pointer to get an entry in the lookup table;
Step 6: If this is a valid entry, release its data in the data cache and allocate the required size in the data cache;
Step 7: If the available size in the data cache is less than the required size, then release more entries in the lookup table in order until there is enough space; send the request to the DRAM, once all the data is returned and written to the cache, The corresponding record of the lookup table is set to be valid;
Step 8: If the cache receives the write request, add a new record to the lookup table;
Step 9: Move the head pointer and get the entry in the lookup table;
Step 10: If this is a valid entry, release its data in the data cache and allocate the required size in the data cache;
Step 11: If the size available in the data cache is less than the required size, then release more entries in the lookup table in order until there is enough space;
Step 12: Then use the data cache to update the information, offset, and request size of the corresponding record in the lookup table, and write the data to the data cache to make the cache line valid.

2. A method for reading and writing data based on variable length cache lines according to claim 1, wherein in the first step, if the head pointer to the tail pointer is greater than 1, the data buffer has (head pointer—The tail pointer—1) is a valid entry; if the head pointer is equal to the tail pointer, the data cache is empty.

3. A method for reading and writing data based on variable length cache lines according to claim 1, wherein said step 2 checks whether the request hits a valid record existing in the lookup table by comparing the read request. Mark and look up the tags in all valid records in the lookup table.

4. A method for reading and writing data based on variable length cache lines according to claim 1, wherein: in order to release data in the data buffer, the size of the cache line corresponding to the data is added to the tail pointer; Cache, write data to the data cache, and add its cache line size to the head pointer; to check if there are k available entries, make sure (header-tail pointer −k) >1.

5. The data read/write method based on variable length cache line according to claim 1, wherein the lookup table stores cache line information of each request, and the cache line information includes a valid bit and a buffer offset. Volume, cache line size, and request tag.

6. A method for reading and writing data based on variable length cache lines according to claim 5, wherein said request includes a tag and an index to a lookup table having a variable effective data length, the data The length is calculated based on the metadata of the request.
